(19) United States
(12) Patent Application Publication
(10) Pub. No.: US 2007/0105632 A1
(43) Pub. Date: May 10, 2007

(54) Driveshaft assembly with torque ring coupling

(76) Inventor: Ronald Brissette, Oxford, MI (US)

Correspondence Address: HARNESS, DICKEY & PIERCE, P.L.C., P.O. BOX 828, BLOOMFIELD HILLS, MI, 48303, US

(21) Appl. No.: 11/645,284

(22) Filed: Dec. 22, 2006

Related U.S. Application Data
(62) Division of application No. 10/926,545, filed on Aug. 26, 2004.

(51) Int. Cl. F16D 3/00

(52) U.S. Cl. 464/51

(57) ABSTRACT

A drivetrain for a motor vehicle having an output member that is configured to transmit propulsive rotary power from a vehicle powertrain, a differential having an input pinion, a propshaft that drivingly couples the input pinion to the output member. The differential is configured to drive a pair of vehicle wheels. A tolerance ring is disposed between the propshaft and one of the output member and the input pinion The tolerance ring frictionally engages the propshaft and the one of the output member and the input member such that at least a portion of the propulsive rotary power is transmitted through the tolerance ring.

### CROSS-REFERENCE TO RELATED APPLICATIONS

This application is a divisional of U.S. patent application Ser. No. 10/926,545, filed Aug. 26, 2004.

### FIELD OF THE INVENTION

The present invention relates to driveshaft assemblies, and more particularly to a torque ring coupling for a driveshaft assembly.

### BACKGROUND OF THE INVENTION

In the manufacture of automotive driveshafts, it is commonplace to join components, such as tubing portions to one another or to end components, such as yokes and spline shafts, by welding. While this process has been effective for its intended purpose, several drawbacks have been noted. These drawbacks include, for example, the necessity that the components be made of materials that are compatibly welded to each other, the necessity that the components be machined or formed with fairly close mating tolerances to ensure that proper alignment may be achieved prior to welding, and distortion that may result from the heat that is generated during the welding operation.

Accordingly, there remains a need in the art for an improved device and method for joining components of a drive shaft in a manner that resists both axial loads and relatively high torsional loads, does not generate a large amount of heat that could distort the components, is relatively inexpensive and which may permit the machining of the components to relatively more open tolerances.

### SUMMARY OF THE INVENTION

In one form, the present teachings provide a driveshaft assembly having a first component defining a bore, a second component, which is received in the bore, and a torque ring. The torque ring is received in the bore and disposed between the first component to the second component. The torque ring includes a plurality of teeth that are at least partially elastically deformed so as to apply a radial load to the first and second components to thereby inhibit relative axial and rotational movement between the first and second components.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of an exemplary motor vehicle having a driveshaft assembly constructed in accordance with the teachings of the present invention;

FIG. 2 is a schematic sectional view of a portion of the driveshaft assembly of FIG. 1;

FIG. 3 is an illustration of a portion of the driveshaft assembly of FIG. 1 showing the torque ring in an end view; and

FIG. 4 is an exploded section view of a portion of the driveshaft assembly of FIG. 1.

### DETAILED DESCRIPTION OF THE PREFERRED EMBODIMENTS

The following description of the preferred embodiment is merely exemplary in nature and is in no way intended to limit the invention, its application, or uses.

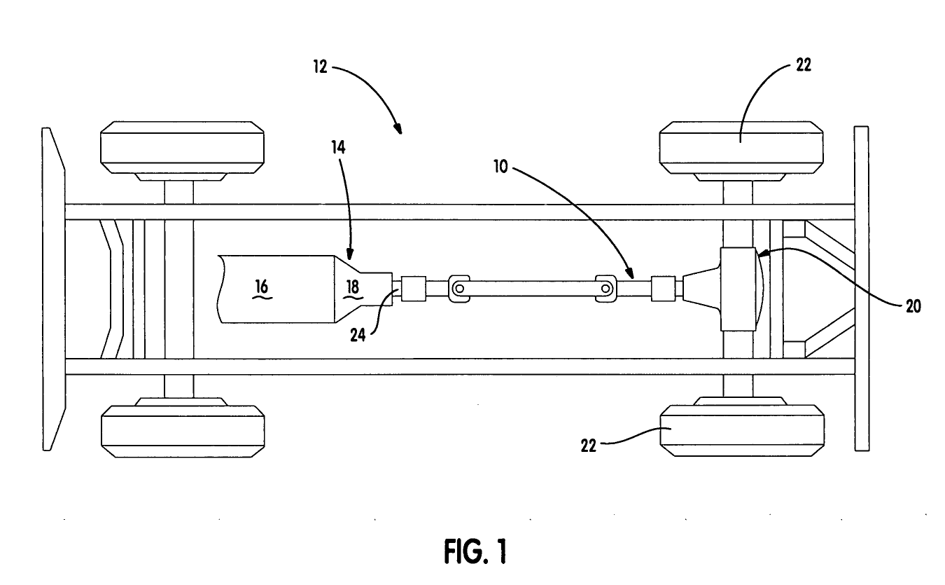

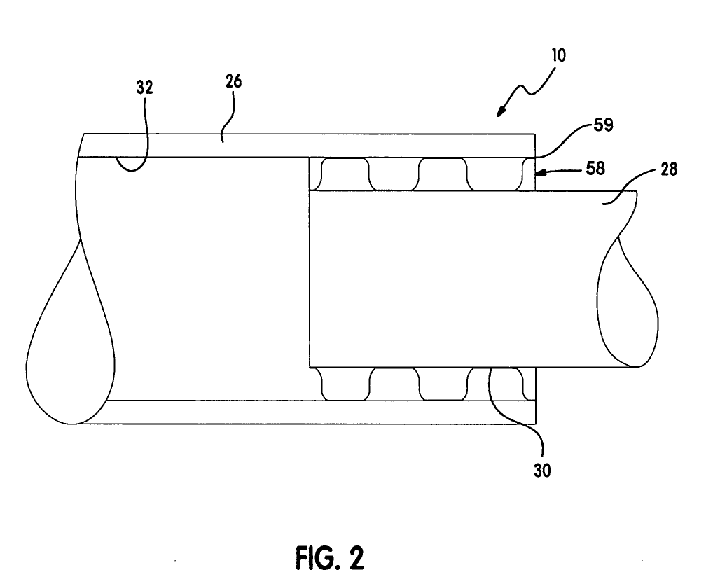

With reference to FIG. 1 of the drawings, a driveshaft assembly 10 constructed in accordance with the teachings of the present invention is illustrated in operative association with an exemplary motor vehicle 12. The vehicle 12 further includes a powertrain 14 coupled via the driveshaft assembly 10 to a driveline. The powertrain 14 includes an engine 16 coupled to a transmission 18. The driveline includes a rear axle 20 coupled to a pair of wheels 22. While in the particular example provided the driveshaft assembly 10 is employed within a motor vehicle, it should be appreciated that the driveshaft assembly 10 may be used in various other applications.

In the particular example provided, the engine 16 is mounted in an in-line or longitudinal orientation along the axis of the motor vehicle 12. The output of the engine 16 is coupled via a conventional clutch or torque converter (not specifically shown) to the input of the transmission 18 in order to transmit rotary power thereto. The input of the transmission 18 is commonly aligned with the output of the engine 16 for rotation about a rotary axis. The transmission 18 further includes an output 24 coupled for rotation to the driveshaft assembly 10. Drive torque is transmitted through the driveshaft assembly 10 to the rear axle 20 where it is selectively transferred to the wheels 22 in a conventional and well known manner.

In the particular example provided, the first component 26 is a shaft that defines a generally cylindrical inner bore 32. The second component 28 is generally cylindrical in shape and is received into the inner bore 32 of the first component 26. The torque ring 30 is also received within the inner bore 32 and is located between the first component 26 and the second component 28. Placement of the torque ring 30 in this manner compresses and deforms the torque ring 30 in an at least partially elastic manner such that radial forces are applied to both the first component 26 and the second component 28. This radial force is sufficiently high as to permit the transmission of torque between the first and second components 26 and 28 without slippage of the torque ring 30, as well as to sufficiently engage the first and second components 26 and 28 as to resist or inhibit relative axial movement therebetween.

In the particular example provided, the first component 26 is a shaft that defines a generally cylindrical inner bore 32. The second component 28 is generally cylindrical in shape and is received into the inner bore 32 of the first component 26. The torque ring 30 is also received within the inner bore 32 and is located between the first component 26 and the second component 28. Placement of the torque ring 30 in this manner compresses and deforms the torque ring 30 in an at least partially elastic manner such that radial forces are applied to both the first component 26 and the second component 28. This radial force is sufficiently high as to permit the transmission of torque between the first and second components 26 and 26 without slippage of the torque ring 30, as well as to sufficiently engage the first and second components 26 and 28 as to resist or inhibit relative axial movement therebetween.

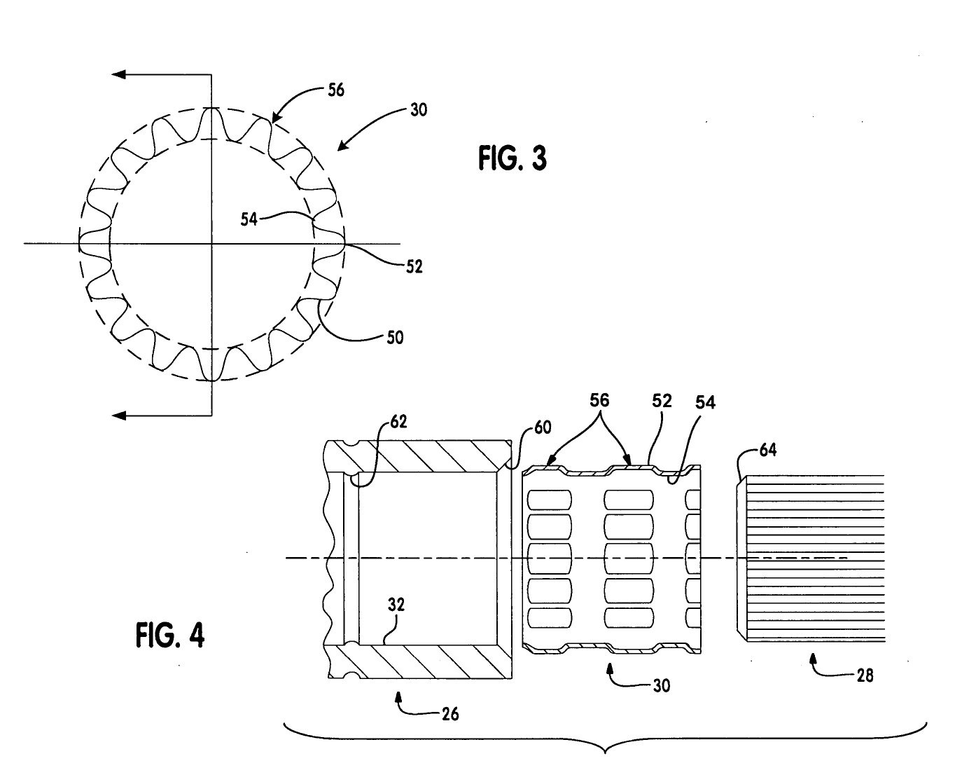

With additional reference to FIGS. 3 and 4, the torque ring 30 is an annular structure having a substantially constant thickness wall member 50 that defines an outer surface 52 and an inner surface 54. The wall member 50 is illustrated to be formed with multiple rows of teeth 56 that extend about the torque ring 30 in a sinusoidally-undulating manner but it will be appreciated that other wave forms or types, which may or may not repeat, may be employed in the alternative. The teeth 56 extend longitudinally along the torque ring generally parallel to a longitudinal axis of the torque ring. Teeth 56 are formed at a terminal end 58 to define an edge 59 of torque ring 30 that follows the sinusoidal path shown in FIG. 3. In a prior-to-assembly state, the outer surface 52 of the torque ring 30 defines an outer diameter that is relatively larger than the inner diameter of the bore 32 in the first component 26, and the inner surface 54 of the torque ring 30 defines an inner diameter that is relatively larger than the outer diameter of the second component 28.

It will be appreciated that the first and second components 26 and 28 may be formed from any desired materials and that welding compatibility is not necessary. Accordingly, it is possible with use of the torque ring of the present invention to join steel and aluminum components to one another in an accurate yet low cost manner.

With additional reference to FIGS. 3 and 4, the torque ring 30 is an annular structure having a wall member 50 that defines an outer surface 52 and an inner surface 54. The wall member 50 is illustrated to be formed with teeth 56 that extend about the torque ring 30 in a sinusoidally-undulating manner but it will be appreciated that other wave forms or types, which may or may not repeat, may be employed in the alternative. In a prior-to-assembly state, the outer surface 52 of the torque ring 30 defines an outer diameter that is relatively larger than the inner diameter of the bore 32 in the first component 26, and the inner surface 54 of the torque ring 30 defines an inner diameter that is relatively larger than the outer diameter of the first component 26.

To facilitate assembly, the first component 26 may include a flared lead in 60, which may be adapted to guide the torque ring 30 into the bore 32, and/or a stop member 62, which may be adapted to prevent the torque ring 30 from being pushed into the bore 32 beyond a predetermined position. The second component 28 may include a tapered shaft lead section 64, which may be adapted to guide the torque ring 30 onto the second component 28. The torque ring 30 may be initially installed to the bore 32 and thereafter the second component 28 may be received into the torque ring 30. Alternatively, the torque ring 30 may be initially installed to the second component 28 and thereafter the second component 28 and the torque ring 30 inserted into the bore 32. Also alternatively, the torque ring 30 may be installed substantially simultaneously into the bore 32 and onto the second component 28.

During installation, the outer and inner surfaces 52 and 54 deform at least partially elastically in a manner which permits the torque ring 30 to generate the radial forces that retain the assembly together. Significantly, the undulating surfaces of the torque ring 30 permit the bore 32 and the second component 28 to be formed to relatively more open tolerances as compared to process that employ welding to retain and transmit torsional loads between the components. Moreover, precision grinding is not necessary, so that turned (or in some situations, as-cast) components may be mated to one another.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A drivetrain for a motor vehicle comprising:
an output member that is adapted to transmit propulsive rotary power from a vehicle powertrain;
a differential having an input pinion, the differential being adapted to drive a pair of vehicle wheels;
a propshaft that drivingly couples the input pinion to the output member; and
a tolerance ring disposed between the propshaft and one of the output member and the input pinion, the tolerance ring frictionally engaging the propshaft and the one of the output member and the input member such that at least a portion of the propulsive rotary power is transmitted through the tolerance ring.

2. The drivetrain of claim 1, wherein the tolerance ring is disposed between a cylindrically-shaped wall member and a cylindrically-shaped shaft member.
